(19) United States
(12) Patent Application Publication
(10) Pub. No.: US 2014/0299595 A1
(43) Pub. Date: Oct. 9, 2014

(54) SYSTEM AND METHOD FOR HOLDING A TEMPERATURE PROBE IN AN INDUCTION HEATING SYSTEM

(71) Applicant: ILLINOIS TOOL WORKS INC., Glenview, IL (US)

(72) Inventors: Alan Dale Sherrill, Appleton, WI (US); George Harold Baus, Kimberly, WI (US)

(73) Assignee: Illinois Tool Works Inc., Glenview, IL (US)

(21) Appl. No.: 13/859,527

(22) Filed: Apr. 9, 2013

(51) Int. Cl. H05B 6/06; H05B 6/36

(52) U.S. Cl. CPC H05B 6/06; H05B 6/362
USPC 219/676

(57) ABSTRACT

A system includes an induction heating assembly having an induction heating element. The system also includes a power supply configured to provide a current to the induction heating element for heating a workpiece. In addition, the system includes a temperature probe configured to provide a signal indicative of a temperature of the workpiece to the power supply. The induction heating assembly is configured to maintain the temperature probe in contact with the workpiece.

### BACKGROUND

The invention relates generally to induction heating systems, and more particularly to systems and methods for holding a temperature probe in a fixed position within an induction heating system.

Induction heating is a method of heating that utilizes a varying magnetic field to heat a workpiece. The varying magnetic field is produced by transmitting an alternating current through an induction heating device. A workpiece located inside or in close proximity to the induction heating device is exposed to the varying magnetic field, inducing movement of electrons and causing a flow of eddy currents within the workpiece. These eddy currents and resistance to current flow within the workpiece cause the temperature of the workpiece to rise. Thus, the amount of heat induced in the workpiece may be controlled by changing the magnetic field strength as a result of varying the amount of alternating current flowing through the induction heating device.

In such induction heating systems, the flow of alternating current is usually adjusted based on feedback from a temperature probe positioned against the workpiece being heated. At the beginning of a heating process, the induction heating system may provide full power output to the induction heating device. As the temperature monitored by the probe approaches a setpoint temperature, the induction heating system automatically decreases power output. At this lowered power output, the induction heating system can maintain the workpiece at the setpoint temperature. Unfortunately, the temperature probe can be shifted out of contact with the workpiece being heated, so that the temperature feedback no longer indicates the increasing temperature of the workpiece. As a result, the induction heating system may not reduce the power output when the setpoint is reached, which could lead to overheating of the workpiece and potentially affect performance of the induction heating device adversely.

### BRIEF DESCRIPTION

In a first embodiment, a system includes an induction heating assembly having an induction heating element. The system also includes a power supply configured to provide a current to the induction heating element for heating a workpiece. In addition, the system includes a temperature probe configured to provide a signal indicative of a temperature of the workpiece to the power supply. The induction heating assembly is configured to maintain the temperature probe in contact with the workpiece.

In another embodiment, a system includes a covering configured to receive and hold a temperature probe of an induction heating system. The probe is configured to monitor a temperature of a workpiece heated by the induction heating system. The covering is configured to be disposed adjacent an induction heating element of the induction heating system such that the probe is held against the workpiece during heating.

In a further embodiment, a method includes providing, via a power supply, current to an induction heating element configured to heat a workpiece. The method also includes controlling, via a controller, the current provided to the induction heating element based on feedback received from a temperature probe. In addition, the method includes maintaining the probe against the workpiece via a covering disposed about the induction heating element. The covering is configured to receive and hold the probe.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an induction heating system in accordance with an embodiment of the present disclosure;

FIG. 2 is a perspective view of an induction heating system used to heat a workpiece in accordance with an embodiment of the present disclosure;

FIG. 3 is a cross sectional view of the induction heating system of FIG. 2, taken within line 3-3, in accordance with an embodiment of the present disclosure;

FIG. 4 is a bottom view of a sleeve for holding a probe of the induction heating system of FIG. 2 in accordance with an embodiment of the present disclosure;

FIG. 5 is a bottom view of the sleeve of FIG. 4 detached from an induction heating blanket in accordance with an embodiment of the present disclosure;

FIG. 6 is a bottom view of an induction heating blanket used to hold a probe of the induction heating system of FIG. 1 in accordance with an embodiment of the present disclosure; and

FIG. 7 is a process flow diagram of a method for operating the induction heating system of FIG. 1 in accordance with an embodiment of the present disclosure.

### DETAILED DESCRIPTION

As described in detail below, provided herein are embodiments of induction heating systems that include mechanisms for receiving and holding a temperature probe against a workpiece being heated by the system. The temperature probe may be utilized to provide feedback indicative of the temperature of the workpiece as an induction heating device heats the workpiece. The induction heating device may include, for example, an induction heating blanket having a coiled heating element for producing a magnetic field and an insulating outer fabric layer. The induction heating system may include a covering with slots for receiving and holding the temperature probe in place, so that the probe does not shift out of contact with the workpiece. In an embodiment, this covering may include the outer fabric layer of the induction heating blanket. In other embodiments, the covering may include a separate sleeve that can be secured around the induction heating device. The slots in the covering may be sized such that the probe cannot be pulled out of position. Consequently, the probe may remain in a desired position against the workpiece, providing accurate temperature feedback for control of the induction heating system.

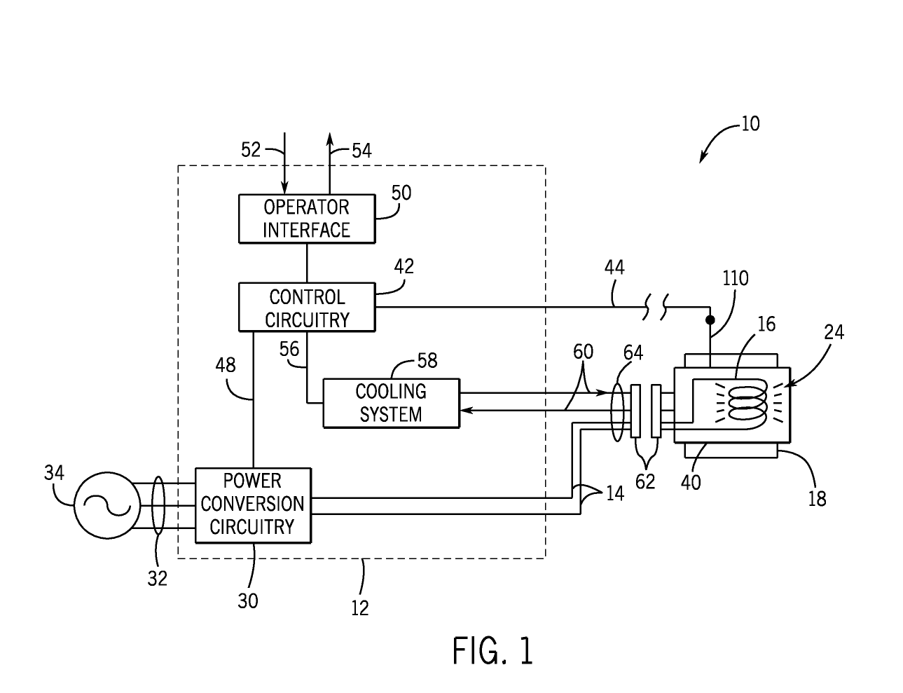

Turning now to the drawings, FIG. 1 illustrates an embodiment of an induction heating system 10 capable of maintaining a temperature probe against a workpiece throughout an induction heating operation. The induction heating system 10 includes a power supply 12 that supplies a power output 14 to an induction coil 16. The power output 14 is a high frequency alternating current power output. Upon receiving the power output 14, the induction coil 16 produces a field 24 (e.g., electromagnetic field). The field 24 may heat a workpiece 18 via induction heating. As will be appreciated by those skilled in the art, induction heating is a phenomenon that occurs when conductive materials are within a changing magnetic or electromagnetic field. The duration, power, frequency, and other heating parameters may vary based at least in part on the type, size, and material of the workpiece 18, among other factors.

Embodiments of the power supply 12 may include power conversion circuitry 30 configured to receive a power input 32 (e.g., alternating current) from a power source 34. The power source 34 may supply an alternating current to the power supply 12 as single- or multi-phase input. In other embodiments, the power source 34 may provide a direct current power input 32, and the power conversion circuitry 30 may include an inverter or any suitable power conversion circuitry to produce an alternating current. The power input 32 may have a first frequency (e.g., 60 Hz). The power conversion circuitry 30 may increase the frequency of the power input 32 to produce an alternating current output of a second frequency (e.g., 20 kHz). For example, the power conversion circuitry 30 may increase the frequency of the power input 32 so that the alternating current output is between approximately 5 kHz to 60 kHz, approximately 7 kHz to 50 kHz, or approximately 10 kHz to 40 kHz. The alternating current output may have any suitable waveform, such as a sine wave, a square wave, a triangle wave, a sawtooth wave, and so forth. In the illustrated embodiment, this alternating current output is the power output 14.

Control circuitry 42 within the power supply 12 provides for control of the induction heating system 10. The control circuitry 42 may receive feedback indicative of a temperature of the workpiece 18 via a sensor line 44, thereby monitoring and controlling a temperature increase toward a predetermined setpoint. The induction coil 16 may raise the temperature of the workpiece 18 by 25, 50, 100, 150, 200, 250, 300, 400, 500 degrees Celsius or more. The sensor line 44 may communicate temperature information collected from a temperature probe 110 held between the coil assembly 40 and the workpiece 18. That is, the sensor line 44 may include an extension of the temperature probe 110, such that a sensor (e.g., thermocouple) of the temperature probe 110 collects temperature measurements, and the sensor line 44 communicates these measurements to the control circuitry 42. As described in greater detail below, present embodiments of the induction heating system 10 are configured to hold the temperature probe 110 against the workpiece 18 throughout the induction heating process.

The control circuitry 42 may be powered at least in part by the power conversion circuitry 30. The control circuitry 42 adjusts the frequency, current, voltage, power, duration, and other operating parameters of the power output 14 produced by the power conversion circuitry 30. An operator interface 50 of the power supply 12 provides for operator input 52 to adjust the settings of the power conversion circuitry 30. For example, the operator interface 50 may be configured to permit operator input 52 of at least one heating parameter. The operator interface 50 may have a plurality of controls (e.g., knobs, dials, buttons, switches, and sliders) to receive operator input 52. Additionally, the operator interface 50 may produce outputs 54 to alert the operator to the condition and state of the power supply 12 and induction coil 16. For example, the operator interface 50 may include a display to indicate the power, current, and/or voltage of the power input 32, the alternating current output, and/or the power output 14. The operator interface 50 may also indicate a duration of a produced field, the temperature of the workpiece 18, whether the coil assembly 40 is coupled to the power supply 12, and/or whether a cooling system 58 is operational, among other properties pertaining to the status and operation of the power supply 12 and the induction coil 16. The operator interface 50 may be located on the power supply 12 or remotely coupled to the power supply 12. For example, the operator interface 50 may be a remote device coupled to the power supply 12 by a wired or wireless connection.

The power supply 12 may have a cooling system 58 to cool the induction coil 16. For example, the cooling system 58 cools the induction coil 16 to provide for sustained production of the field 24 and/or a high current through the induction coil 16. The control circuitry 42 controls the cooling system 58 via a control line 56. The cooling system 58 directs a cooling fluid to the induction coil 16 through a first cooling conduit 60. During production of the field 24, the induction coil 16 becomes warm due to the current passing through the induction coil 16 and/or due to radiation from the induction heated workpiece 18. The first cooling conduit 60 may be removably coupled to the coil assembly 40 and the induction coil 16 by a coupling 62. The power output 14 and the first cooling conduit 60 together may be part of an input conduit 64 that may be removably coupled by the coupling 62 to the coil assembly 40. For example, the input conduit 64 may include a water cooled conductive wire (e.g., Litz wire) to transmit the power output 14 to the induction coil 16. Alternatively, the power output 14 and the first cooling conduit 60 may be separately coupled to the induction coil 16 and the coil assembly 40. The cooling fluid controlled by the cooling system 58 may include air, water, or refrigerant (e.g., ammonia, R-134a, R-410a). The cooling system 58 circulates the cooling fluid through the induction coil 16 as shown by the return arrows of the cooling conduit 60. The control circuitry 42 may control the induction heating system 10 so that the induction coil 16 will not produce a field 24 unless the cooling system 58 is cooling the induction coil 16.

The control circuitry 42 may provide for a programmability of the induction heating system 10. Through the operator interface 50, the operator may adjust the heating parameters of the power supply 12 to affect the field 24 by the induction coil 16 and the heating of the workpiece 18. Heating parameters include the current, voltage, power, frequency, duration of the field 24 and setpoint temperature of the workpiece 18. In some embodiments, the control circuitry 42 has a memory for storing computer readable instructions, and a processor for processing the instructions. For example, the operator inputs 52 the type, thickness, or material of the workpiece 18 to be heated. Upon initiating the induction heating process, the control circuitry 42 causes the induction coil 16 to produce a field 24 of a predetermined frequency and intensity until temperature feedback from the sensor line 44 indicates that the workpiece 18 is near the setpoint temperature. In some embodiments, the operator inputs and adjusts heating parameters for various types, dimensions, configurations, materials, and temperature setpoints of the workpiece 18. These adjusted or programmed heating parameters may be stored in memory.

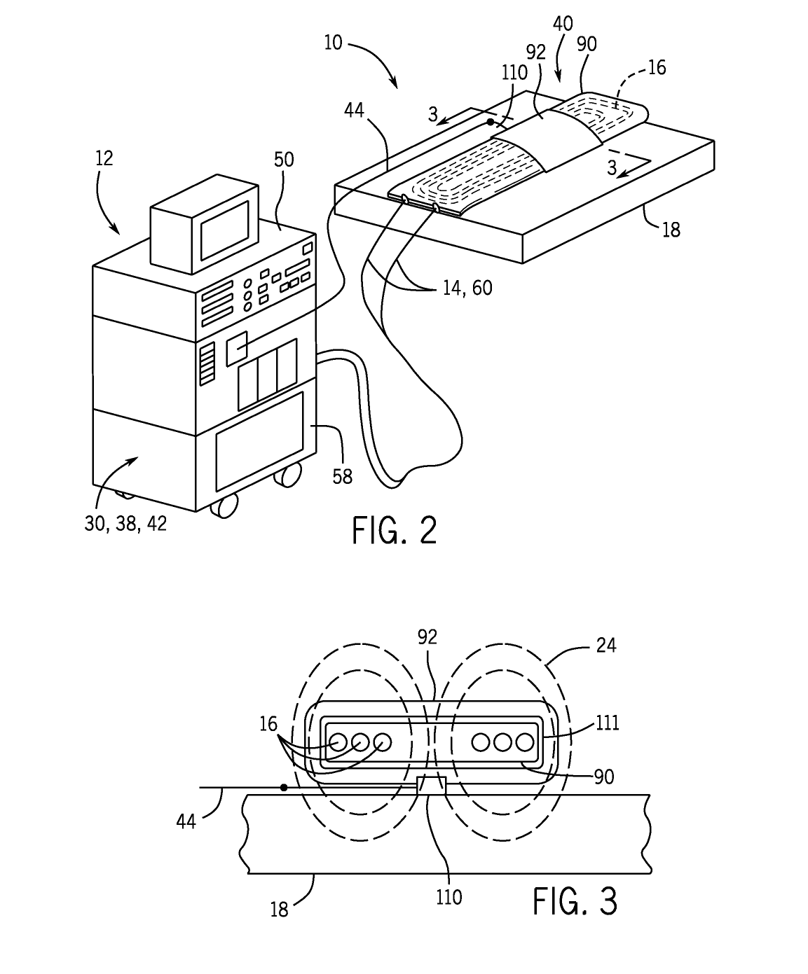

FIG. 2 is a perspective view of an embodiment of the induction heating system 10 being used to heat the workpiece 18. In the illustrated embodiment, the workpiece 18 is a flat piece of material. As previously discussed, the power supply 12 receives temperature measurements via a sensor line 44 in order to control the induction heating process. Once the temperature of the workpiece 18 reaches a desired setpoint, as indicated by the reading from a temperature probe at the end of the sensor line 44, the control circuitry 42 changes the power output to the induction coil 16 for heating the workpiece 18. The change in power output may maintain the workpiece 18 within a desired temperature range for the duration of the induction heating operation.

In the illustrated embodiment, the coil assembly 40 is an induction heating blanket 90. The induction heating blanket 90 may include the induction coil 16, disposed either inside of or against an edge of a blanket of material that is positioned over the workpiece 18. The induction heating blanket 90 may be placed atop a portion of the workpiece 18 that is to be heated, as shown. In other embodiments, such as when the workpiece 18 is a pipe, the induction heating blanket 90 may be wrapped around and secured against the workpiece 18. In this case, a temperature probe at the end of the sensor line 44 may be held against the workpiece 18 via a compressive force exerted by the induction heating blanket 90 on the workpiece 18. However, when the induction heating blanket 90 is merely placed on the workpiece 18, as shown in FIG. 2, the temperature probe may be moved or kicked out of position between the induction heating blanket 90 and the workpiece 18. If the temperature probe loses contact with the workpiece 18, the temperature feedback provided to the power supply 12 via the sensor line 44 may be lower than the actual temperature of the workpiece 18. In response, the induction coil 16 may continue to heat the workpiece 18 above its setpoint temperature and acceptable temperature range. This could overheat the workpiece 18, and the high temperature of the workpiece 18 could adversely affect certain equipment (e.g., induction heating blanket 90).

Present embodiments of the induction heating system 10 are configured to maintain the probe in contact with the workpiece 18, even when the induction heating blanket 90 is laid across the workpiece 18 without applying significant force to the temperature probe located therebetween. In the illustrated embodiment, for example, the induction heating system 10 includes a sleeve 92 that is disposed about the induction heating blanket 90. The sleeve 92 may be detachable from the induction heating blanket 90 and configured to hold the temperature probe. When the induction heating blanket 90 with the sleeve 92 is disposed over the workpiece 18, the temperature probe is held in place against the workpiece 18. If the sensor line 44 is jerked, the sleeve 92 may hold the temperature probe in place so that it is not pulled out from between the induction heating blanket 90 and the workpiece 18.

FIG. 3 is a cross sectional view of the induction heating system 10, taken within line 3-3. In the illustrated embodiment, a temperature probe 110 is held against the workpiece 18 in order to detect the increasing temperature of the workpiece 18 during operation of the induction heating blanket 90. As discussed above, the power supply 12 provides an alternating current to the induction coil 16, which in the illustrated embodiment is located inside the induction heating blanket 90. The current produces the varying electromagnetic field 24, which causes the temperature of the workpiece 18 to rise. In the illustrated embodiment, the temperature probe 110, which may include a thermocouple probe, is attached to the sleeve 92. The sleeve 92 is secured about the induction heating blanket 90, as shown. In other embodiments, however, the temperature probe 110 may be attached directly to the induction heating blanket 90.

The induction heating blanket 90 may include the induction coil 16 covered by, or disposed adjacent to, a layer of insulation coated with a heat resistant material. In an embodiment, for example, the induction coil 16 may be covered by, or disposed adjacent to, a layer of Silica 3D Needlemat insulation coated with silicone rubber. In some embodiments, the induction heating blanket 90 may be disposed in a blanket sleeve 111. The blanket sleeve 111 may be made from Kevlar or any other suitable material. This blanket sleeve 111 is separate from the illustrated probe sleeve 92, and the probe sleeve 92 may be positioned over the blanket sleeve 111 of the induction heating blanket 90.

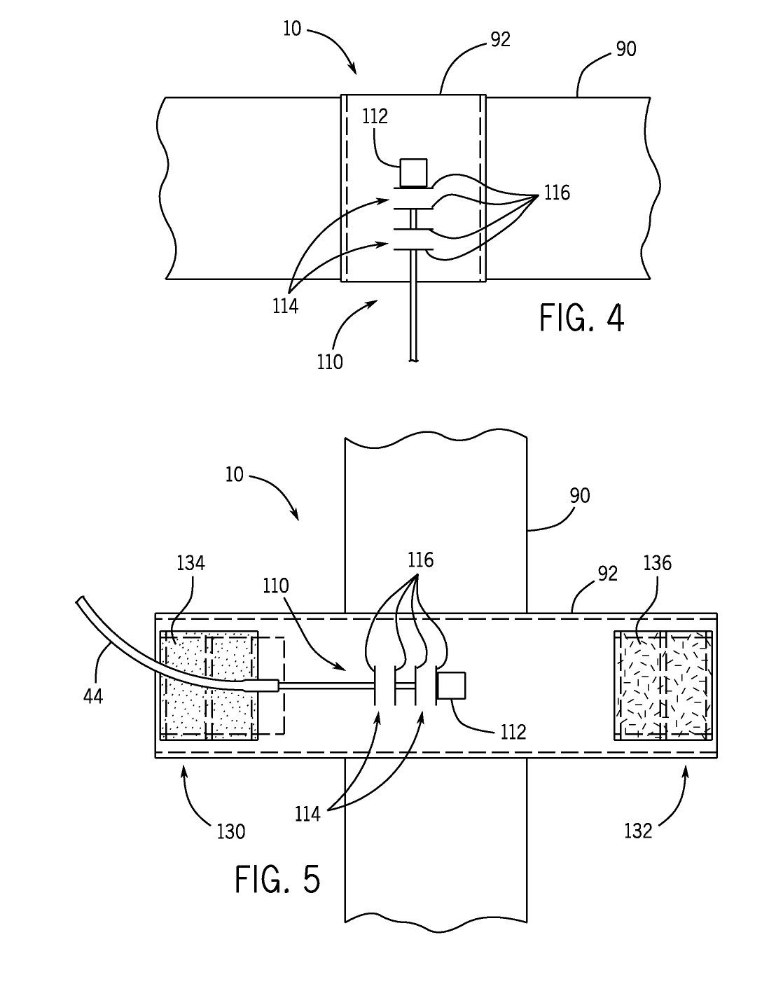

FIG. 4 is a bottom view of the sleeve 92 wrapped about the induction heating blanket 90 and holding the temperature probe 110. This view shows the side of the induction heating blanket 90 that is placed against the workpiece 18 during the induction heating process. The temperature probe 110 may be a thermocouple device with a shaped end 112 (e.g., a brass plate) to be held in contact with the heated surface of the workpiece 18. In the illustrated embodiment, the sleeve 92 includes two sections 114 of fabric, through which the temperature probe 110 may be inserted. The sections 114 of fabric may be spaced such that the temperature probe 110, which is a certain length (e.g., twelve inches) can be woven therebetween. The sections 114 of fabric may be formed between two or more slots 116 (two for defining each section 114) that are cut into the sleeve 92. The slots 116 may be button-hole stitches that are sewn into an outer layer of fabric of the sleeve 92. The slots 116 define boundaries of the sections 114 of fabric through which the temperature probe 110 may be woven. These sections 114 of fabric between the slots 116 may function as bridging material to forms a path through which the temperature probe 110 may be inserted into the sleeve 92. Through the formation of these sections 114, the slots 116 are configured to receive and hold the temperature probe 110. The slots 116 may be sized small enough to engage with or interfere with the shaped end 112 of the temperature probe 110, but large enough to allow the shaped end 112 to be fed through.

The temperature probe 110 may be removed from the sleeve 92 via careful manipulation back through the slots 116. However, if the sensor line 44 is jerked, the shaped end 112 may catch on the sections 114 formed by the slots 116 and remain in place against the workpiece 18. Because the temperature probe 110 is removable from the sleeve 92, the same sleeve 92 may be used with any number of different temperature probes 110. There may be other numbers (e.g., one, three, four, or more) of sections 114 formed by the slots 116 sewn into the fabric. In some embodiments, temperature probes 110 of different lengths may be interchangeable with the sleeve 92, and the probes 110 may be inserted into and held by different numbers of the available fabric sections 114, depending on the probe length.

The sleeve 92 may be constructed from one or more of the same materials as the induction heating blanket 90. That is, the sleeve 92 may include a layer of insulation coated in a heat resistant material to withstand the temperature of the workpiece 18. For example, the sleeve 92 may be made of Silica 3D Needlemat insulation coated with silicone rubber on the outer surface. In some embodiments, the sleeve 92 may be made from Kevlar, similar to the blanket sleeve 111 of the induction heating blanket 90. It should be noted that the sleeve 92 may be constructed from any other desirable material, and is not limited to the same material as the induction heating blanket 90. Whatever material is used for the sleeve 92, it is desirable for the material to be relatively durable and able to withstand temperatures to which the workpiece 18 is preheated.

In some embodiments, the sleeve 92 (or other covering) that is configured to hold the temperature probe 110 is detachable from the induction heating blanket 90. This allows an operator to use the same sleeve 92 to hold the temperature probe 110 adjacent to any desired induction heating blanket 90, or other induction heating component. As an example, FIG. 5 is a bottom view of the sleeve 92 detached from the induction heating blanket 90. The sleeve 92 may include an attachment mechanism for selectively attaching a first end 130 of the sleeve 92 to a second end 132 of the sleeve 92. In the illustrated embodiment, the attachment mechanism includes portions 134 and 136 of hook-and-loop material sewn onto the first and second ends 130 and 132 of the sleeve 92, respectively. The first portion 134 may include the hook material that, when placed in contact with the second portion 136 of loop material, removably couples the ends 130 and 132 of the sleeve 92 around the inductive heating blanket 90. In some embodiments, similar material may be stitched onto an opposite side of the sleeve 92 as well, so that any excess material of the sleeve 92 may be folded back and held down when the sleeve 92 is positioned around a relatively small induction heating blanket 90. The sleeve 92 may be relatively easy to construct by cutting and/or sewing the slots 116 in the sleeve 92 and sewing the hook-and-loop material thereon. Other types of attachment mechanisms may be used, and these may be adjustable so that the sleeve 92 can be attached to different sized induction heating blankets 90.

The temperature probe 110 may be removable, so that any temperature probe 110 can provide temperature feedback for any induction heating blanket 90. In this way, the sleeve 92 may be incorporated with any existing induction heating system 10, in order to secure the temperature probe 110 against the workpiece 18 and provide an accurate temperature reading. Indeed, the sleeve 92 may be coupled to induction heating elements that do not include a fabric blanket (e.g., induction heating blanket 90). Instead, the system 10 may include a bundle of loose cables or a liquid cooled coil configured to provide inductive heating to the workpiece 18. The sleeve 92 may be configured to attach to different sized induction heating blankets 90 as well. That is, the sleeve 92 may be configured to fit over induction heating blankets 90 that are 7.5 inches wide, 9.0 inches wide, 10.1 inches wide, or any other standard size.

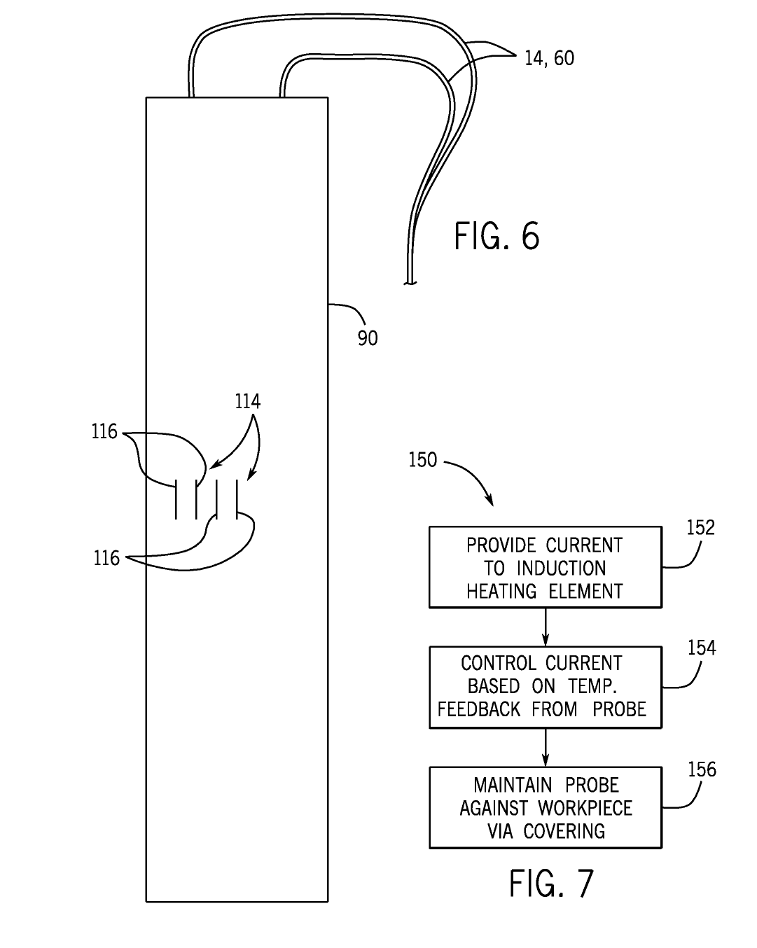

Ultimately, the sleeve 92 is used to position the temperature probe 110 against the workpiece 18, while extending the life of the induction heating blanket 90 by providing some protection for the blanket's outer surface. However, other embodiments of the induction heating system 10 may allow for the placement of the temperature probe 110 without the use of the sleeve 92. FIG. 6, for example, is a bottom view of an induction heating blanket 90 used to hold the temperature probe 110 of the induction heating system 10. The slots 116 (i.e., button-hole stitches that form the sections 114 of fabric) may be sewn directly into the induction heating blanket 90. More specifically, the sections 114 may be formed within the blanket sleeve 111 of the induction heating blanket 90 to receive and hold the temperature probe 110 in place. As before, if the temperature probe 110 or sensor line 44 is jerked, the temperature probe 110 may not be pulled out of the induction heating blanket 90. As previously mentioned, the induction heating blanket 90 may include the blanket sleeve 111 (e.g., Kevlar outer surface) that is generally resistant to the temperatures of the heated workpiece 18. Although the sleeve 92 may allow for greater flexibility in attaching the temperature probe 110 to different induction heating elements, the illustrated embodiment requires no adjustment for size of the induction heating blanket 90 and has fewer parts to manage. Furthermore, it may be more fully integrated with a given induction heating blanket 90.

FIG. 7 is a process flow diagram of a method 150 for operating the induction heating system 10 of the presently disclosed embodiments. The method 150 includes providing (block 152) current to the induction heating element (e.g., induction heating blanket 90) to heat the workpiece 18. The method 150 also includes controlling (block 154) the current based on temperature feedback from the temperature probe 110. A signal indicative of the temperature measured by the temperature probe 110 is sent to the control circuitry 42 via the sensor line 44, and the control circuitry 42 controls the power output from the power supply 12 to the induction heating element for heating the workpiece 18. Further, the method 150 includes maintaining (block 156) the temperature probe 110 against the workpiece 18 via a covering. In some embodiments this covering may be an outer material covering of the induction heating blanket 90, as shown in FIG. 6. In other embodiments, such as that shown in FIG. 5, the covering may be the sleeve 92 that is removably attachable to the induction heating blanket 90.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
an induction heating assembly comprising an induction heating element;
a power supply configured to provide a current to the induction heating element for heating a workpiece; and
a temperature probe configured to provide a signal indicative of a temperature of the workpiece to the power supply;
wherein the induction heating assembly is configured to maintain the temperature probe in contact with the workpiece.

2. The system of claim 1, wherein the induction heating assembly comprises a detachable sleeve configured to be disposed about the induction heating element, wherein the sleeve is configured to maintain the temperature probe in contact with the workpiece.

3. The system of claim 2, wherein the sleeve is configured to be secured against the induction heating element via an attachment mechanism.

4. The system of claim 1, wherein the induction heating element is enclosed in an outer layer of fabric of the induction heating assembly, wherein the outer layer is configured to maintain the temperature probe in contact with the workpiece.

5. The system of claim 1, wherein the induction heating assembly comprises two or more slots formed in a layer of fabric, wherein the slots are configured to receive and hold the temperature probe.

6. The system of claim 5, wherein the temperature probe comprises a shaped end configured to catch on a section of fabric formed by the slots.

7. The system of claim 1, wherein the induction heating element comprises an induction heating blanket, a bundle of loose cables, or a liquid cooled coil.

8. The system of claim 1, comprising a controller configured to receive the signal indicative of the temperature of the workpiece and to determine, based on the signal, an appropriate current for the induction heating element.

9. A system, comprising:
a covering configured to receive and hold a temperature probe of an induction heating system, wherein the covering is configured to be disposed adjacent an induction heating element of the induction heating system such that the probe is held against a workpiece when the covering is holding the temperature probe.

10. The system of claim 9, wherein the covering comprises two or more slots formed in a layer of fabric, wherein the slots are configured to receive and hold the temperature probe.

11. The system of claim 10, wherein the slots are sized to catch a shaped end of the temperature probe on a section of fabric formed by the slots.

12. The system of claim 9, wherein the covering comprises insulation coated with a heat resistant material to withstand the temperature of the workpiece.

13. The system of claim 9, wherein the covering comprises an outer layer of fabric of an induction heating blanket that comprises the induction heating element.

14. The system of claim 9, wherein the covering comprises a sleeve configured to be disposed about an induction heating blanket, wherein the induction heating blanket comprises the induction heating element.

15. The system of claim 14, wherein the sleeve comprises an attachment mechanism for selectively attaching a first end of the sleeve to a second end of the sleeve opposite the first end to secure the sleeve about the induction heating element.

16. The system of claim 14, wherein the sleeve is configured to be disposed about at least one of multiple induction heating elements, wherein each of the multiple induction heating elements comprise a unique size or shape.

17. A method, comprising:
providing, via a power supply, current to an induction heating element configured to heat a workpiece;
controlling, via a controller, the current provided to the induction heating element based on feedback received from a temperature probe; and
maintaining the probe against the workpiece via a covering disposed about the induction heating element, wherein the covering is configured to receive and hold the probe.

18. The method of claim 17, comprising receiving and holding the probe in two or more slots formed in the covering.

19. The method of claim 17, wherein the covering comprises a detachable sleeve configured to be secured about the induction heating element via an attachment mechanism.

20. The method of claim 17, wherein the covering comprises a fabric outer layer of an induction heating blanket, and the induction heating blanket comprises the induction heating element.
